(19) United States
(12) Patent Application Publication
(10) Pub. No.: US 2008/0017635 A1
(43) Pub. Date: Jan. 24, 2008

(54) Microwave Crisping Platform System

(76) Inventor: Jeffrey T. Watkins, Princeton, MN (US)

Correspondence Address: NEUSTEL LAW OFFICES, LTD., 2534 SOUTH UNIVERSITY DRIVE, SUITE 4, FARGO, ND, 58103, US

(21) Appl. No.: 11/457,894

(22) Filed: Jul. 17, 2006

(51) Int. Cl. H05B 6/80

(52) U.S. Cl. 219/730

(57) ABSTRACT

A microwave crisping platform system that is opened and locked by the consumer prior to heating food within a microwave. The microwave crisping platform system includes a platform, a first end and a second end pivotally attached to opposing ends of the platform, a base extending between the first end and the second end, a center support extending between the platform and the base, and at least one wing member pivotally extending from the center support for selectively locking the platform in a raised position with respect to the base.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to microwave platforms and more specifically it relates to a microwave crisping platform system that is opened and locked by the consumer prior to heating food within a microwave.

2. Description of the Related Art

Any discussion of the prior art throughout the specification should in no way be considered as an admission that such prior art is widely known or forms part of common general knowledge in the field.

Conventional platforms for heating food within a microwave have been in use for years. An exemplary conventional platform is comprised of a non-foldable structure having a circular or rectangular shape with sidewalls supporting the platform. The platforms may be constructed of pressed paperboard or with sidewalls glued to one another. Some conventional platforms for microwaves are comprised of a platform with sidewalls that have are pivotally attached to the platform and wherein the sidewalls have mechanical locks in the corner.

### BRIEF SUMMARY OF THE INVENTION

In view of the foregoing disadvantages inherent in the known types of crisping platforms for microwaves now present in the prior art, the present invention provides a new microwave crisping platform system construction wherein the same can be opened and locked by the consumer prior to heating food within a microwave.

The general purpose of the present invention, which will be described subsequently in greater detail, is to provide a new microwave crisping platform system that has many of the advantages of the crisping platforms for microwaves mentioned heretofore and many novel features that result in a new microwave crisping platform system which is not anticipated, rendered obvious, suggested, or even implied by any of the prior art crisping platforms for microwaves, either alone or in any combination thereof.

To attain this, the present invention generally comprises a platform, a first end and a second end pivotally attached to opposing ends of the platform, a base extending between the first end and the second end, a center support extending between the platform and the base, and at least one wing member pivotally extending from the center support for selectively locking the platform in a raised position with respect to the base.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a microwave crisping platform system that will overcome the shortcomings of the prior art devices.

A second object is to provide a microwave crisping platform system that can be opened and locked by the consumer prior to heating food within a microwave.

Another object is to provide a microwave crisping platform system that may have various platform sizes, shapes and heights.

An additional object is to provide a microwave crisping platform system that does not require expensive equipment to manufacture.

A further object is to provide a microwave crisping platform system that are efficient to distribute.

Another object is to provide a microwave crisping platform system that increases the strength of the cooking surface without increasing the caliper of the paperboard used.

Another object is to provide a microwave crisping platform system that ensures that a significant portion of the heat is transferred to the food instead of heating the floor of the microwave oven.

A further object is to provide a microwave crisping platform system that allows for the escape of excess moisture that is released in the cooking process.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention in the raised position.

FIG. 2 is a top view of the present invention in the raised position.

FIG. 3 is a bottom view of the present invention in the raised position.

FIG. 4 is an end view of the present invention in the raised position.

FIG. 5a is a side view of the present invention in the lowered position.

FIG. 5b is a side view of the present invention in the intermediate position.

FIG. 5c is a side view of the present invention in the raised and unlocked position.

FIG. 5d is a side view of the present invention in the raised and locked position.

FIG. 6 is a top view of the present invention unassembled.

FIG. 7 is an upper perspective view of an alternative embodiment of the present invention illustrating a rectangular platform.

FIG. 8 is a top view of the alternative embodiment unassembled.

### DETAILED DESCRIPTION OF THE INVENTION

A. Overview

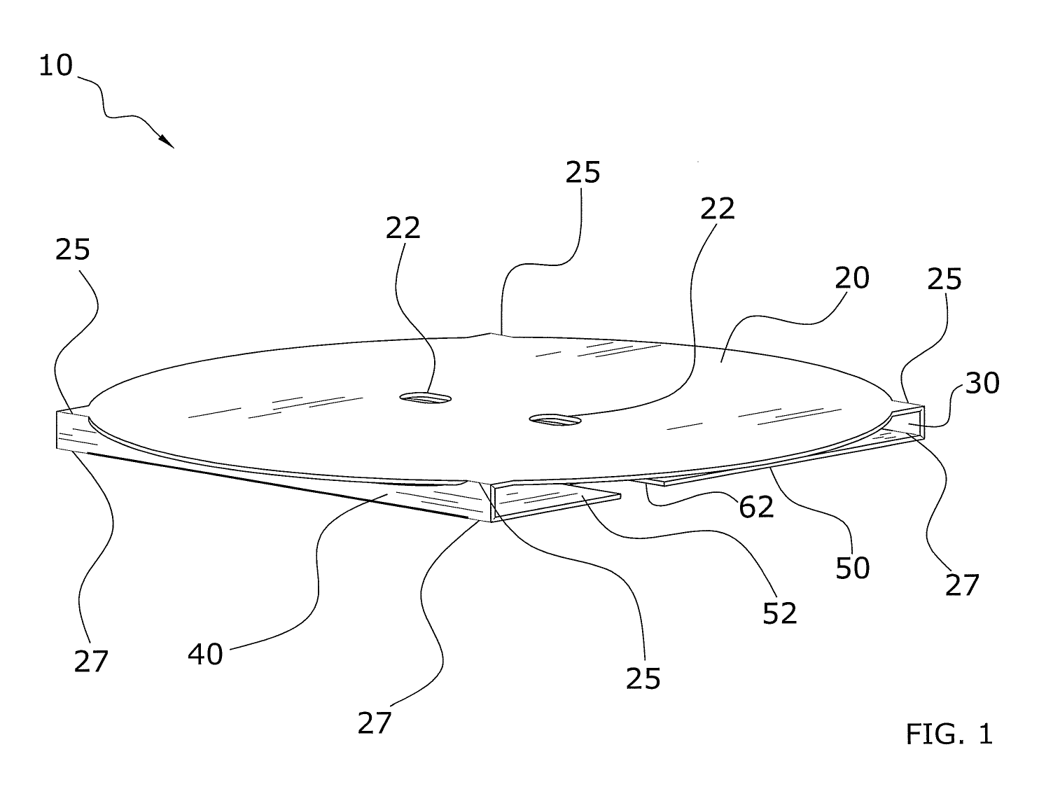

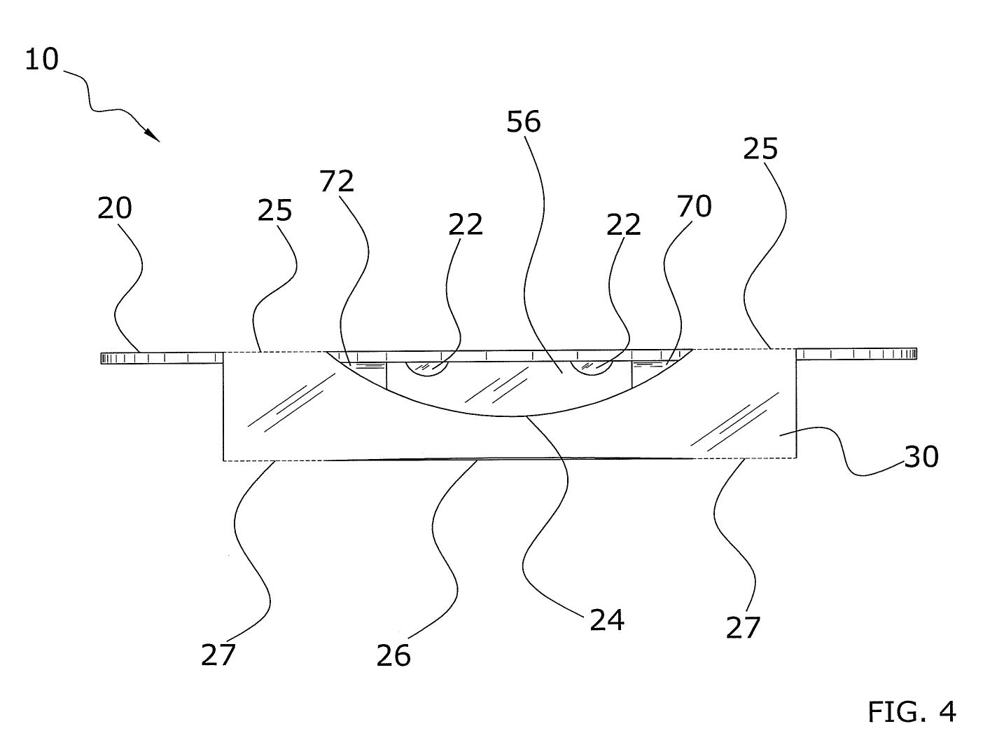

Turning flow descriptively to the drawings, in which similar reference characters denote similar elements throughout the several views, FIGS. 1 through 8 illustrate a microwave crisping platform system 10, which comprises a platform 20, a first end 30 and a second end 40 pivotally attached to opposing ends of the platform 20, a base extending between the first end 30 and the second end 40, a center support 56 extending between the platform 20 and the base, and at least one wing member pivotally extending from the center support 56 for selectively locking the platform 20 in a raised position with respect to the base.

B. Platform

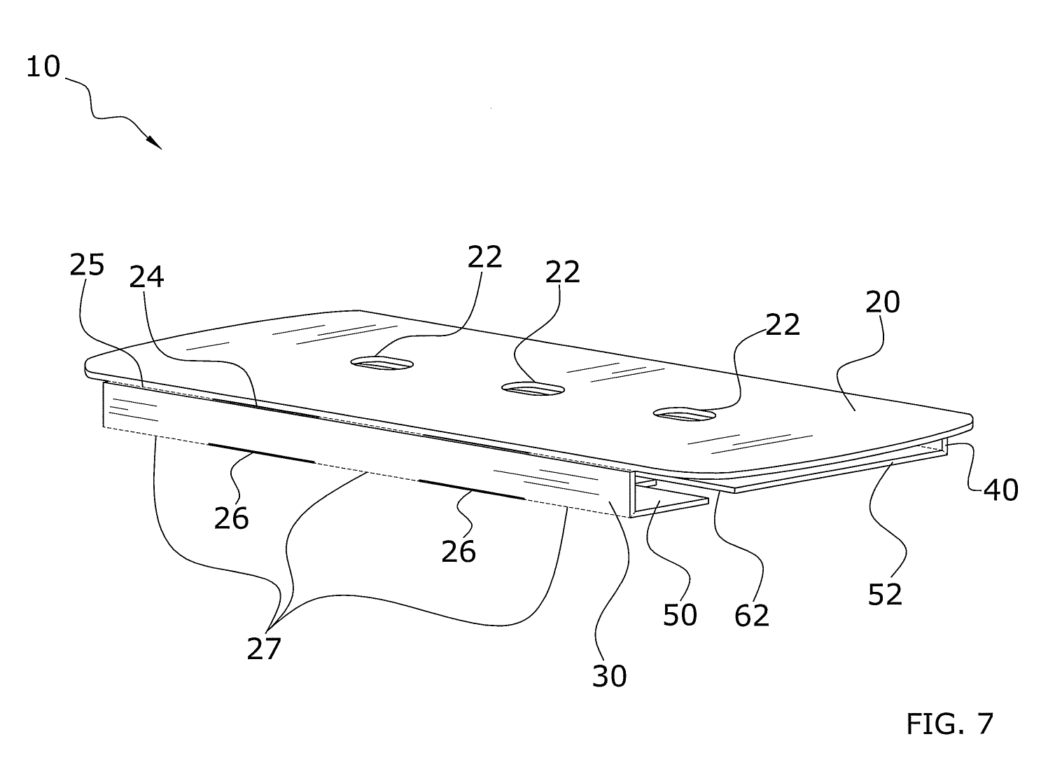

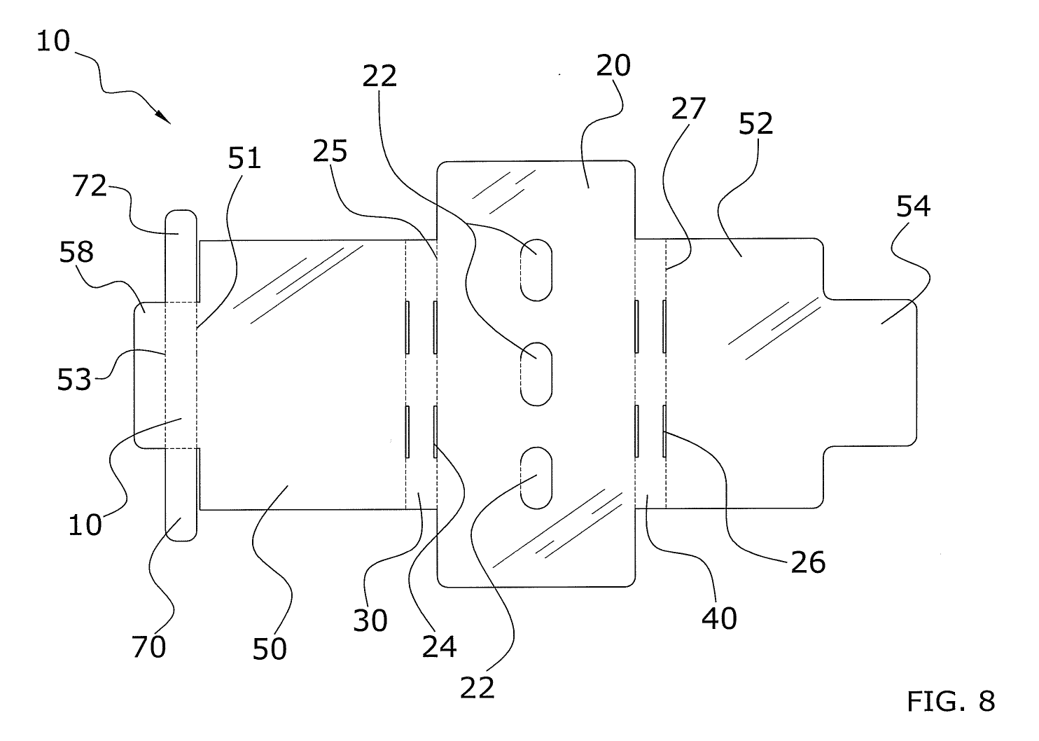

FIGS. 1, 2 and 6 best illustrate an exemplary platform 20 having a circular shape. The platform 20 may have various other shapes including but not limited to rectangular as illustrated in FIGS. 7 and 8 of the drawings. The platform 20 is of sufficient size and shape to support a food item to be cooked within a microwave (e.g. pizza).

The platform 20 is preferably constructed of paperboard however various other materials may be utilized to construct the platform 20. The platform 20 is further preferably coated with an electrically conductive material so that the conductive layer becomes heated by the microwave radiation as illustrated in U.S. Pat. No. 4,825,025 and which is incorporated by reference.

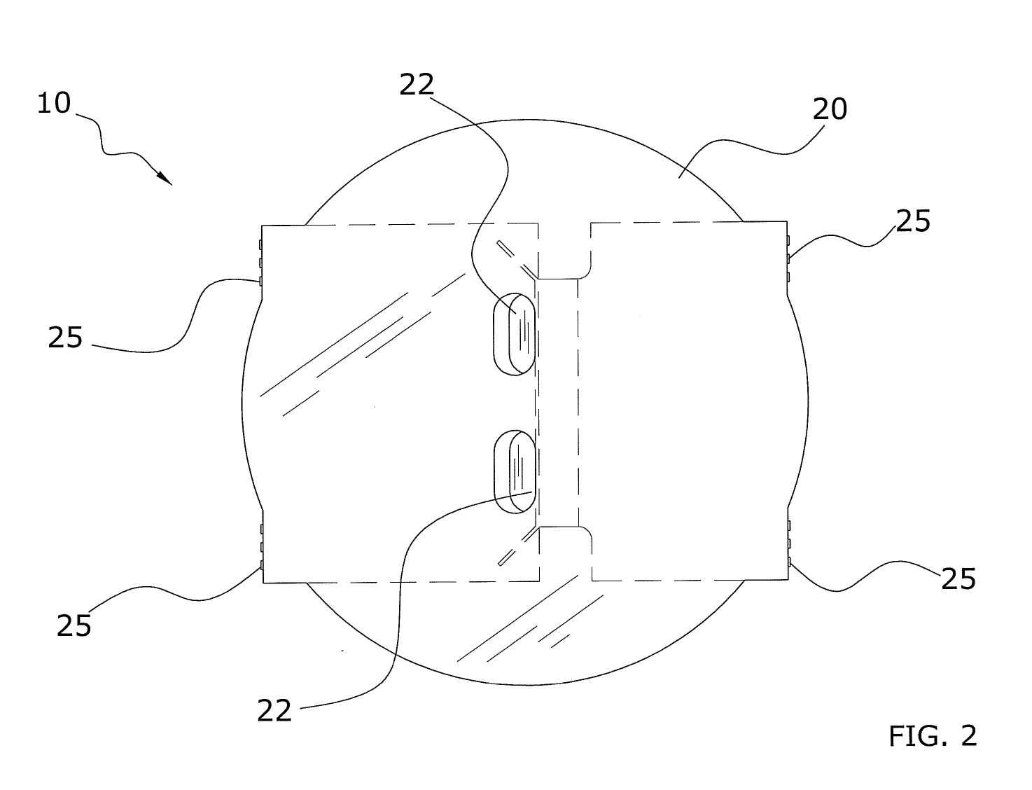

The platform 20 preferably includes one or more vent members 22 that are partially or fully depressible to allow air to pass beneath the platform 20 during cooking of the food. The vent members 22 may remain closed or may be depressed by the user the user prior to cooking. The vent members 22 are preferably pivotally attached to the platform 20 with the remaining portion cutout to create a vent when the vent members 22 are depressed beneath the platform 20 as best illustrated in FIG. 2 of the drawings.

C. Ends

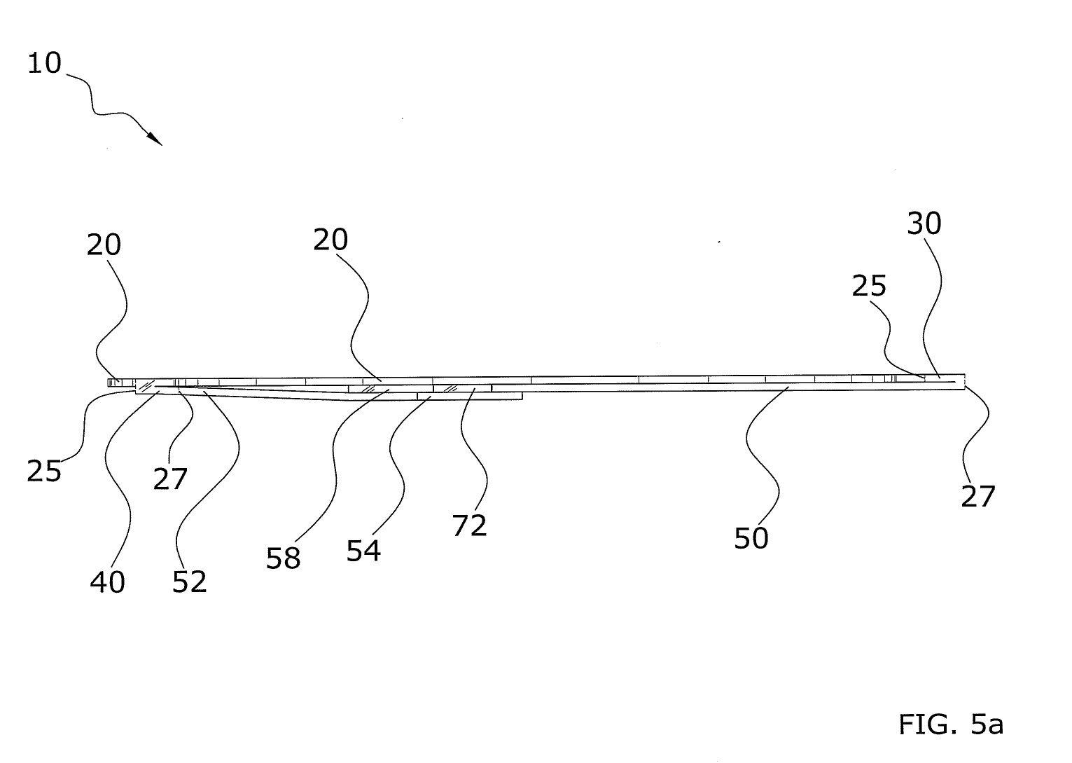

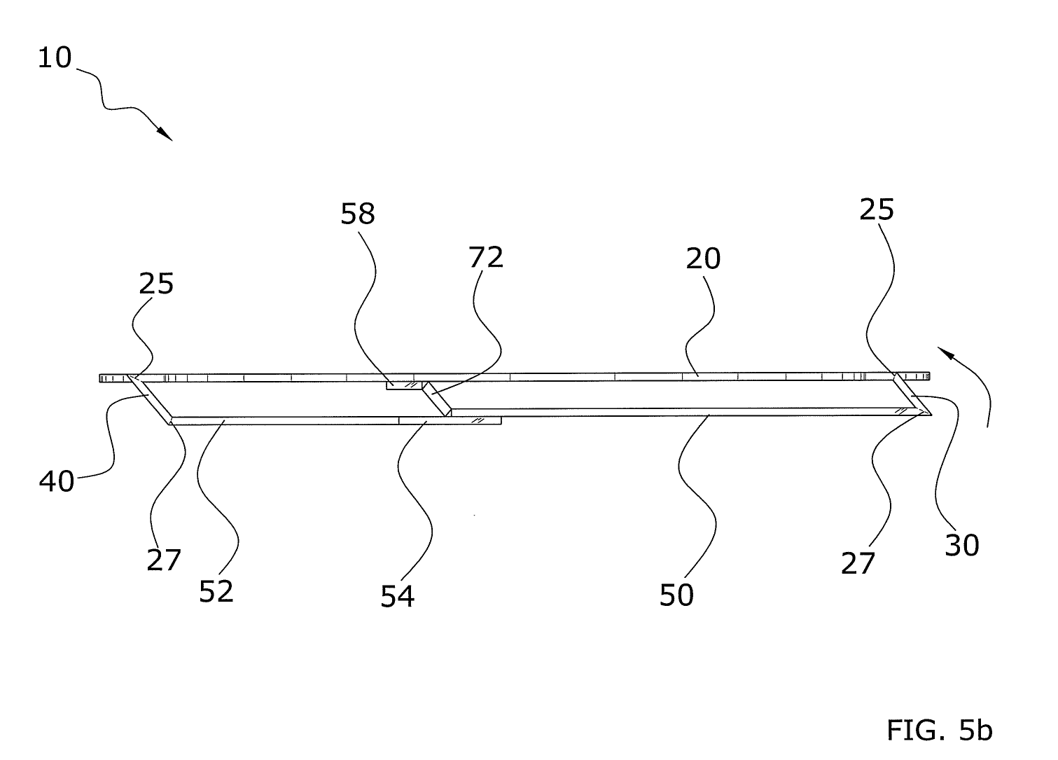

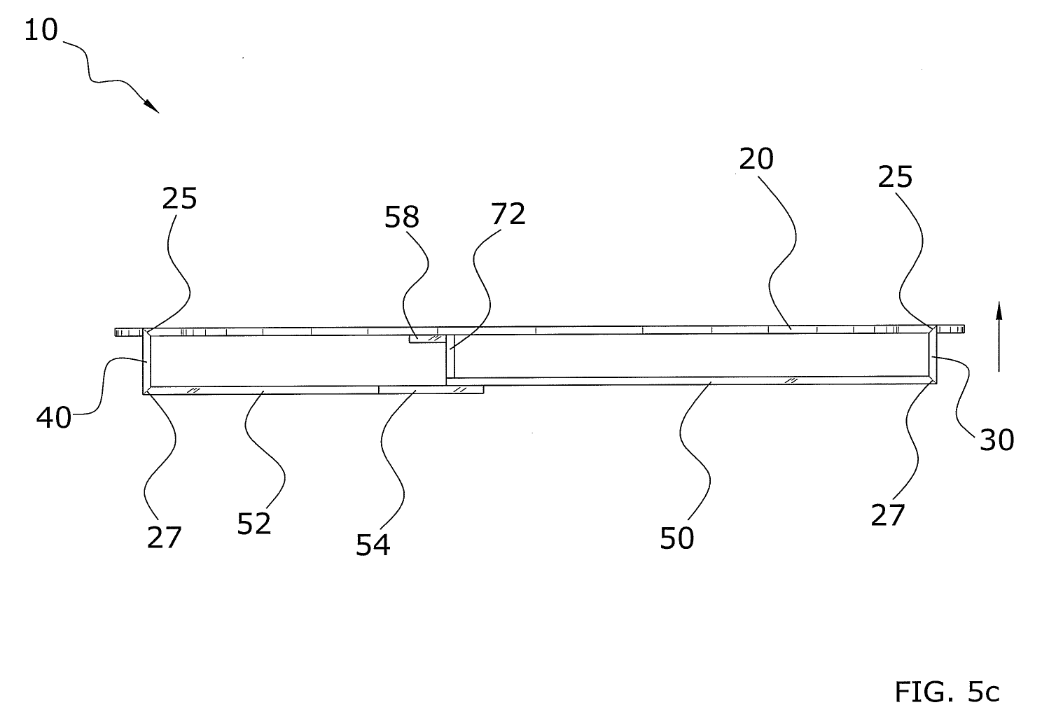

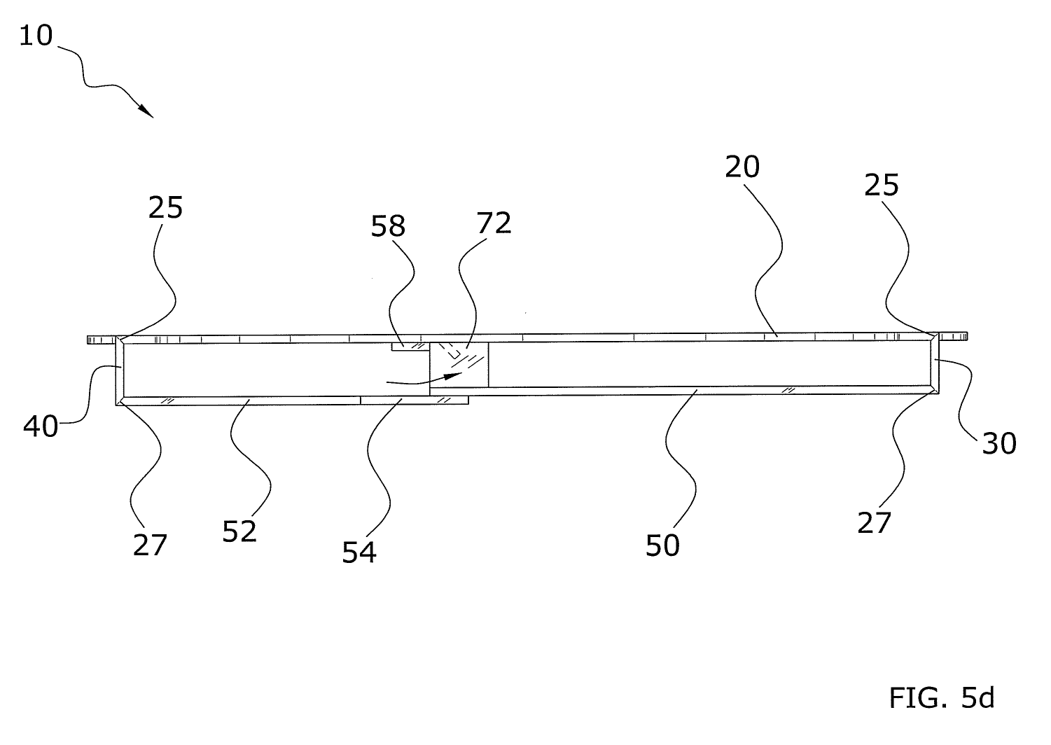

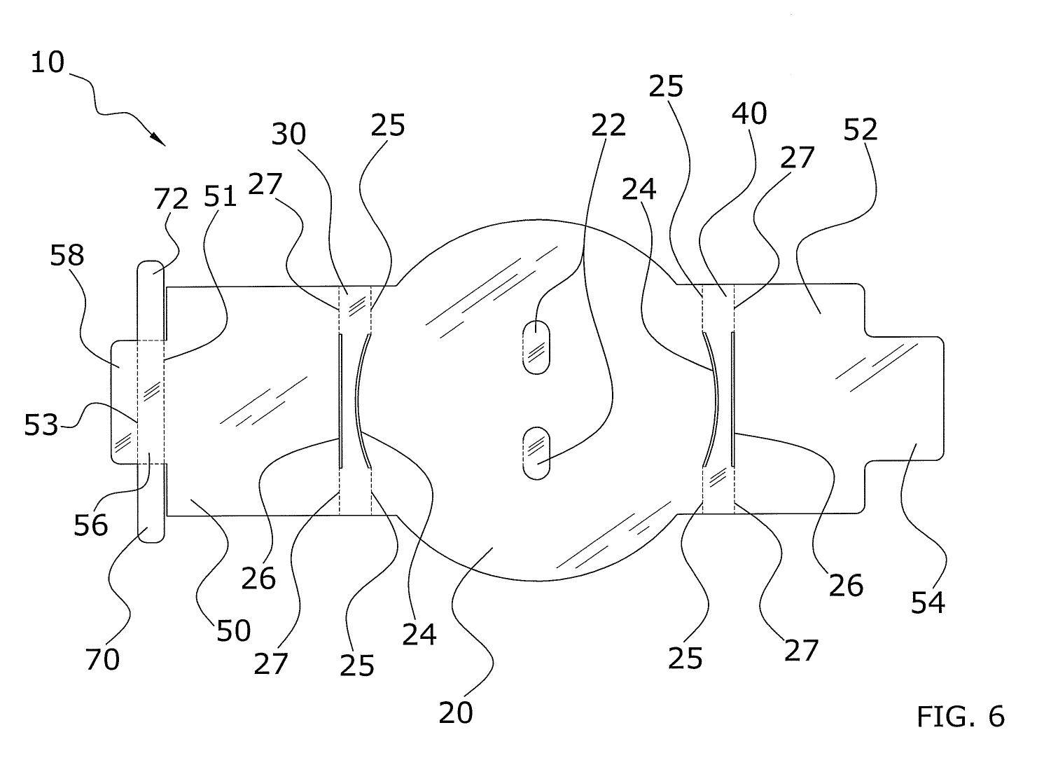

As shown in FIGS. 5c, 5d and 6 of the drawings, a first end 30 and a second end 40 are pivotally attached to opposing ends of the platform 20. The first end 30 and the second end 40 preferably have a substantially similar height to provide a level platform 20 during cooking within a microwave. The height of the first end 30 and the second end 40 is preferably at least 0.5 inches to provide sufficient elevation and therefore insulation from a surface in a microwave thereby ensuring that a significant portion of the heat generated passes to the food being heated.

A first pivot axis of the first end 30 and a second pivot axis of the second end 40 are preferably substantially parallel to one another as best illustrated in FIG. 6 of the drawings. The first pivot axis and the second pivot axis are preferably substantially transverse with respect to a longitudinal axis of the platform 20 as further shown in FIG. 6 of the drawings. However, the first pivot axis and the second pivot axis may be substantially parallel with respect to a longitudinal axis of the platform 20 as shown in FIGS. 7 and 8 of the drawings.

As best illustrated in FIG. 6 of the drawings, a pair of opposing upper end slots 24 extend about the perimeter of the platform 20 to allow for the platform 20 to extend outwardly past the first end 30 and the second end 40 when assembled. The upper end slots 24 are connected or near a pair of opposing upper end perforations 25 which define the first pivot axis and the second pivot axis of the first end 30 and the second end 40 respectively as further shown in FIG. 6 of the drawings.

As best illustrated in FIG. 6 of the drawings, a pair of opposing lower end slots 26 extend substantially centrally between the ends 30, 40 and the bases 50, 52. The lower end slots 26 are connected or near a pair of opposing lower end perforations 27 which define the respective pivot axis of the bases 50, 52 with respect to the ends 30, 40 respectively as further shown in FIG. 6 of the drawings.

D. Base

The base 50, 52 is pivotally attached to and extends between the first end 30 and the second end 40 as illustrated in FIGS. 5c, 5d and 6 of the drawings. The base is preferably substantially parallel to the platform 20 at all times as illustrated in FIGS. 5a through 5d of the drawings.

The base is preferably comprised of a first base 50 pivotally extending from the first end 30 and a second base 52 pivotally extending from the second end 40 as illustrated in FIGS. 5b and 6 of the drawings. When the present invention is assembled, the first base 50 and the second base 52 are attached to one another with a conventional attaching means (e.g. glue, adhesive) as shown in FIGS. 5b through 5d of the drawings.

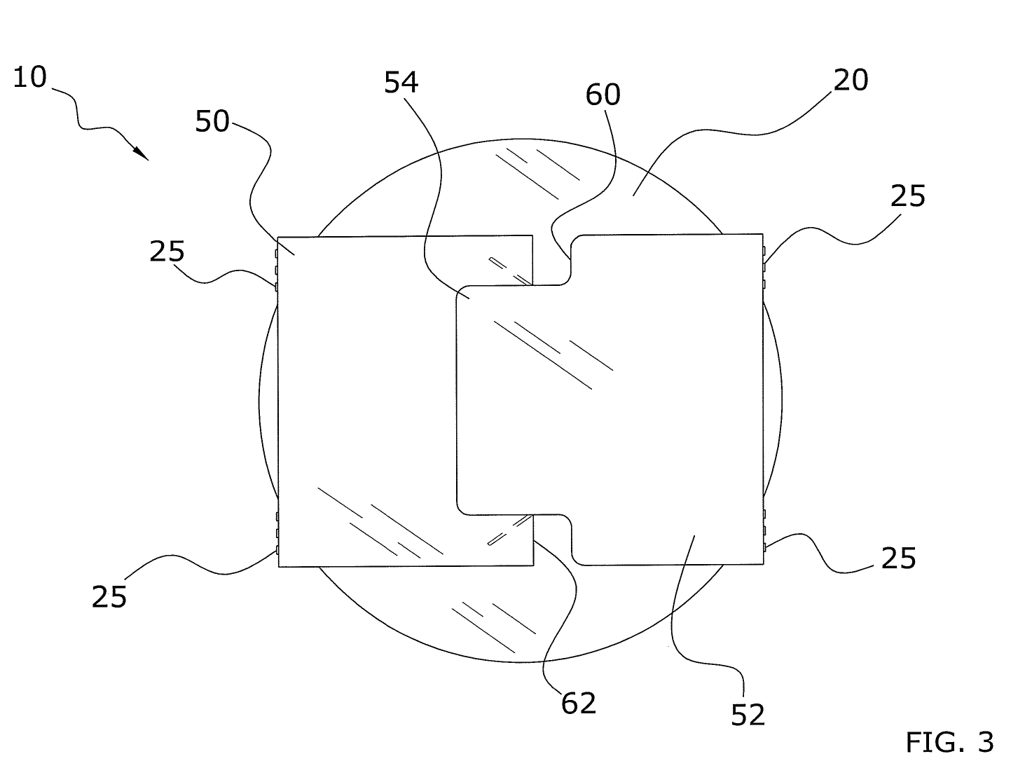

The second base 52 preferably includes an extended portion 54 that is narrower than the second base 52 as illustrated in FIG. 6 of the drawings. The extended portion 54 is then partially attached to the first base 50 thereby creating a first opening 60 and a second opening 62 on opposing sides thereof to provide access to the wing members 70, 72 as best illustrated in FIG. 3 of the drawings.

E. Center Support

FIGS. 5b through 5d of the drawings illustrate a center support 56 pivotally extending between the platform 20 and the base 50, 52. The center support 56 may be centrally located or offset from a central location of the platform 20. The center support support 56 assists in supporting the wait of the food supported on the platform 20 when the platform 20 is in the raised position as shown in FIGS. 5c and 5d of the drawings.

The center support 56 is preferably pivotally attached to an end of the first base 50 as best illustrated in FIG. 6 of the drawings. A plurality of base perforations 51 preferably extend along the pivot axis of the center support 56 and the first base 50 as shown in FIG. 6.

At least one wing member 70, 72 pivotally extends from the center support 56 for selectively locking the platform 20 in a raised position with respect to the base as shown in FIGS. 2, 5d and 6 of the drawings. It is preferably to have a first wing member 70 and a second wing member 72 pivotally extending from opposing sides of the center support 56 as shown in FIG. 6 of the drawings. The wing members 70, 72 preferably extend past the first base 50 as shown in FIG. 6 of the drawings to provide convenient access to the same during usage by the consumer. The pivot axis for the wing members 70, 72 is preferably substantially transverse with respect to the pivot axis of the center support 56 with respect to the first base 50.

An attachment member 58 preferably is pivotally attached to and extending from the center support 56 opposite of the first base 50 as shown in FIG. 6 of the drawings. Extended perforations 53 are aligned with the pivot axis of the attachment member 58 as shown in FIG. 6 of the drawings. When the present invention is assembled, the attachment member 58 is preferably attached to a bottom surface of the platform 20 to secure the center support 56 to the platform 20 as best illustrated in FIGS. 5b through 5c of the drawings.

F. Assembly of Invention

The present invention is preferably comprised of a single piece of paperboard or similar material as illustrated in FIG. 6 of the drawings. The single piece of paperboard is thereby simply cutout with a conventional die from a larger sheet of paperboard. The perforations, slots and pivot points may be added after or during the cutting process. The paperboard is further preferably coated partially or fully on one side with an electrically conductive material so that the conductive layer becomes heated by the microwave radiation as illustrated in U.S. Pat. No. 4,825,025 and which is incorporated by reference.

The single piece of paperboard as shown in FIG. 6 initially in a substantially flat state. The first base 50 is first preferably folded inwardly adjacent to the bottom surface of the platform 20. The attachment member 58 is thereafter attached to the bottom surface of the platform 20. The second end 40 along with the second base 52 is then pivoted inwardly with respect to the platform 20 so that the extended portion 54 overlaps the first base 50. The extended portion 54 is then attached to the first base 50 forming the structure in a lowered state.

G. Usage of Invention

In use, the present invention is shipped to a food manufacturer or other party in a substantially flat state as illustrated in FIG. 5a of the drawings. The food is positioned upon the upper surface of the platform 20 and thereafter packaged appropriately. When the consumer purchases the food item, the consumer removes the present invention with the food item from the packaging. The consumer then pivots the present invention so that the ends 30, 40 are in a substantially upright position thereby placing the platform 20 in the raised position as illustrated in FIG. 5c of the drawings. The consumer then manipulates one or more of the wing members 70, 72 and pivots the same inwardly so that the wing members 70, 72 engage the bottom surface of the platform 20 and the lower surface of the base 50, 52 at an angle with respect to the center support 56 as respect to the center support 56 as shown in FIG. 5d of the drawings. The wing members 70, 72 may be positioned at various angles that prevent the folding of the present invention to the lowered position. The vent members 22 may then be depressed to allow for air flow beneath the platform 20 and the food item then placed upon the platform 20. The present invention along with the food item supported upon the platform 20 is then placed within the microwave where the heating of the food item occurs. The upper surface of the platform 20 assists in heating and crisping the food item. When the cooking is complete, the food item is removed from the platform 20 and the present invention may then be cleaned for repeated use or discarded.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims (and their equivalents) in which all terms are meant in their broadest reasonable sense unless otherwise indicated. Any headings utilized within the description are for convenience only and have no legal or limiting effect.

1. A microwave crisping platform system, comprising:
a platform;
a first end and a second end pivotally attached to opposing ends of said platform;
a base pivotally extending between said first end and said second end;
a center support pivotally extending between said platform and said base, wherein said center support is positioned between said first end and said second end; and
at least one wing member pivotally extending from said center support for selectively locking said platform in a raised position with respect to said base when said at least one wing member is positioned at an angle with respect to said center support.

2. The microwave crisping platform system of claim 1, wherein a first pivot axis of said first end and a second pivot axis of said second end are substantially parallel to one another.

3. The microwave crisping platform system of claim 2, wherein said first pivot axis is substantially parallel with respect to a longitudinal axis of said platform.

4. The microwave crisping platform system of claim 1, wherein said platform is comprised of a circular shape.

5. The microwave crisping platform system of claim 1, wherein said platform is comprised of a rectangular shape.

6. The microwave crisping platform system of claim 1, wherein said platform includes at least one vent member depressible to allow air to pass beneath said platform.

7. The microwave crisping platform system of claim 1, wherein said first end and said second end are each at least 0.5 inches in height.

8. The microwave crisping platform system of claim 1, wherein said base is substantially parallel to said platform.

9. The microwave crisping platform system of claim 1, wherein said base is comprised of a first base pivotally extending from said first end and a second base pivotally extending from said second end.

10. The microwave crisping platform system of claim 9, wherein said first base and said second base are attached to one another.

11. A microwave crisping platform system, comprising:
a platform;
a first end and a second end pivotally attached to opposing ends of said platform;
a base pivotally extending between said first end and said second end; and
at least one wing member pivotally extending from said platform or said base between said first end and said second end for selectively locking said platform in a raised position with respect to said base when said at least one wing member is positioned at an angle with respect to said center support.

12. The microwave crisping platform system of claim 11, wherein a first pivot axis of said first end and a second pivot axis of said second end are substantially parallel to one another.

13. The microwave crisping platform system of claim 12, wherein said first pivot axis is substantially parallel with respect to a longitudinal axis of said platform.

14. The microwave crisping platform system of claim 11, wherein said platform is comprised of a circular shape.

15. The microwave crisping platform system of claim 11, wherein said platform is comprised of a rectangular shape.

16. The microwave crisping platform system of claim 11, wherein said platform includes at least one vent member depressible to allow air to pass beneath said platform.

17. The microwave crisping platform system of claim 11, wherein said first end and said second end are each at least 0.5 inches in height.

18. The microwave crisping platform system of claim 11, wherein said base is substantially parallel to said platform.

19. The microwave crisping platform system of claim 11, wherein said base is comprised of a first base pivotally extending from said first end and a second base pivotally extending from said second end, wherein said first base and said second base are attached to one another.

20. (canceled)

21. A microwave crisping platform having a raised position and a lowered position, wherein said lowered position is a substantially flat structure and wherein said raised position is substantially raised structure, comprising:
a platform;
a first end and a second end pivotally attached to opposing ends of said platform;
a base pivotally extending between said first end and said second end;
wherein said base is substantially parallel to said platform in both said raised position and said lowered position;
wherein a first pivot axis of said first end and a second pivot axis of said second end are substantially parallel to one another;
wherein said first pivot axis is substantially parallel with respect to a longitudinal axis of said platform;
a center support pivotally extending between said platform and said base;
wherein said center support is centrally positioned between said first end and said second end; and
at least one wing member pivotally extending from said center support for selectively locking said platform in a raised position with respect to said base, wherein when said at least one wing member is substantially parallel with respect to said center support said platform is adjacent to said base in said lowered position, and wherein when said at least one wing member is positioned at a non-parallel angle with respect to said center support said platform is supported above said base in said raised position and wherein said at least one wing member prevents movement of said platform with respect to said base.
